(19) United States
(12) Patent Application Publication
(10) Pub. No.: US 2026/0041598 A1
(43) Pub. Date: Feb. 12, 2026

(54) SELF-DRIVEN WEARABLE PHYSICAL THERAPY SYSTEM

(71) Applicant: Villanova University, Villanova, PA (US)

(72) Inventors: Qianhong Wu, Malvern, PA (US); Bo Li, Malvern, PA (US); Bingjie Zhou, Devon, PA (US); Bchara Sidnawi, Ardmore, PA (US); Yun Li, Bryn Marw, PA (US)

(73) Assignee: Villanova University, Villanova, PA (US)

(21) Appl. No.: 19/362,324

(22) Filed: Oct. 17, 2025

Related U.S. Application Data
(63) Continuation-in-part of application No. 18/319,107, filed on May 17, 2023.
(60) Provisional application No. 63/342,681, filed on May 17, 2022.

(51) Int. Cl. A61H 7/00; A61H 9/00

(52) U.S. Cl. CPC A61H 7/001; A61H 9/0021; A61H 2201/1238; A61H 2201/1253; A61H 2201/1642; A61H 2201/165; A61H 2201/1654; A61H 2201/5071; A61H 2205/106; A61H 2205/12

(57) ABSTRACT

Devices and methods for providing a therapeutic stimulus to a subject. The device may have a therapeutic portion, a reservoir, a tube operatively coupling the therapeutic portion and the reservoir, and a working material disposed within the therapeutic portion, reservoir, and tube. The tube may be configured to transfer pressure applied to the reservoir by a movement of the subject from the reservoir to the therapeutic portion. The therapeutic portion may be configured to engage a first portion of the subject. The reservoir may be remote from the therapeutic portion and configured to engage a second portion of the subject.

### CROSS-REFERENCE TO RELATED APPLICATIONS

This application claims priority, as a continuation-in-part, to U.S. Non-Provisional patent application Ser. No. 18/319,107, titled “Wearable Garment for Muscle Stimulation,” filed May 17, 2023, and to U.S. Provisional Patent Application No. 63/342,681, filed May 17, 2022, the entirety of both of which are incorporated herein by reference.

### FIELD

This application generally relates to systems and methods for compression, stimulating, therapeutic, and/or rehabilitative techniques. More specifically, this disclosure pertains to wearable devices that can provide continuous pulse-driven compression, stimulating, therapeutic, and/or rehabilitative effects.

### BACKGROUND

Evidence demonstrates that early and advanced rehabilitative treatment greatly improves long-term outcomes for subjects who have suffered from various conditions, such as stroke and peripheral arterial disease. Example treatments often include regular physical therapy sessions involving exercise and massage to accelerate muscle growth and nerve recovery. Physical therapy—including nerve stimulation, blood flow promoting resistance training and/or muscle massage—is known to accelerate the path to motor function recovery.

However, current resistance stimulation applications occur only at intervals, with idle periods of non-stimulation occurring in between. In addition, while health systems and technology have made it easier for professionals to deliver muscle stimulation in patients' homes, such services are not currently available to all patients and still rely on set intervals of therapy determined by the at-home program.

### SUMMARY

Various embodiments disclosed herein can be worn by a subject even when they are engaged in normal, daily activity requiring physical exertion, leading to a positive shift in the subject's long-term prognosis through continuous, passive stimulation provided by a flexible garment that can be fit tightly around a portion of the subject, such as an arm or leg that may be wrapped. Such embodiments may also be used to treat pulled muscles and other conditions, and may benefit professional sports athletes, people on fitness programs, bodybuilders, etc. in a wide range of applications.

In accordance with some embodiments, a device for providing a therapeutic stimulus to a subject is provided. The device may comprise a material, a network of flexible cells, at least one channel, and a working material. The material may be configured to cover a portion of the subject and may have an inner surface for engaging a surface of the subject and an exterior surface facing away from the surface of the subject. The network of flexible cells may be coupled to the material and each flexible cell may have an internal cavity. The working material may be disposed within the internal cavities of the flexible cells. The at least one channel may be arranged to allow exchange of the working material between flexible cells due to application of force upon the network from movement of the surface of the subject.

In accordance with some embodiments, at least one of the flexible cells may comprise a perimeter wall, an inner layer, and an outer layer. The perimeter wall may be proximate to and extending away from an exterior surface of a material engaging the subject. The inner layer may be proximate to the exterior surface of the material and coupled to the perimeter wall. The outer layer may be substantially parallel to the inner layer and displaced from the inner layer by the wall and may be coupled to the perimeter wall, and the wall, inner layer, and outer layer may define the internal cavity of the at least one flexible cell.

In accordance with some embodiments, the at least one channel may be a plurality of channels. At least one of the channels may be coupled to and extend from an opening in the perimeter wall of one cell and an opening in the perimeter wall of another cell. The channel may thereby operatively couple the internal cavity of the one cell to the internal cavity of the other cell. A working material in the internal cavity of each cell may be redistributable by pressure differentials caused by the forces resulting from the movement of the subject exerted on the inner surface of the material that is transmitted into the internal cavity of the cell.

In accordance with some embodiments, a therapeutic garment is provided. The garment may comprise a plurality of cells, a plurality of channels, and a working material. At least one of the plurality of cells may comprise a perimeter wall, an inner layer configured to be placed proximate to a subject, and an outer layer substantially parallel to the inner layer and displaced from the inner layer by the wall. The wall, inner layer, and outer layer may define an internal cavity. At least one channel of the plurality of channels may couple the internal cavity of one cell of the plurality of cells to the internal cavity of another cell of the plurality of cells. The working material may be disposed in the internal cavity of at least one of the plurality of cells and the plurality of channels. The plurality of cells, plurality of channels, and working material may form a cell pack.

In accordance with some embodiments a method for applying a therapeutic treatment to a subject is provided. The method may include attaching a therapeutic device to cover a portion of a subject. The therapeutic device may comprise a material, a network of flexible cells, at least one channel, and a working material. The material may be configured to engage a portion of the subject. The network of flexible cells may be coupled to the material and each flexible cell has an internal cavity. The working material may be disposed within the internal cavities of the flexible cells. The at least one channel may be arranged to allow exchange of the working material between flexible cells due to application of force upon the network from movement of the surface of the subject. In some embodiments, moving at least a part of the portion of the subject relative to an inner layer of at least one cell may displace the at least one inner layer of that cell, raising pressure of the working fluid in the internal cavity of the cell, resulting in pressure changes to other cells of the plurality of cells. In some embodiments, moving the inner layer of at least one other cell of the plurality of cells may result from the pressure change in the at least one other cell. The movement of the inner layer of at least one other cell of the plurality of cells provides a targeted therapeutic treatment to the subject.

In accordance with some embodiments a device for providing a therapeutic stimulus to a subject is provided. The device may comprise a therapeutic portion, a reservoir, a tube operatively coupling the therapeutic portion and the reservoir, and a working material disposed within the therapeutic portion, reservoir, and tube. The tube may be configured to transfer pressure applied to the reservoir by a movement of the subject from the reservoir to the therapeutic portion. The therapeutic portion may be configured to engage a first portion of the subject. The reservoir may be remote from the therapeutic portion and configured to engage a second portion of the subject.

In accordance with some embodiments, a therapeutic garment is provided. The garment may comprise a therapeutic portion, a reservoir, a tube operatively coupling the therapeutic portion and the reservoir, and a working material disposed within the therapeutic portion, the reservoir, and the tube. The therapeutic portion may be configured to engage a first portion of a subject. The reservoir may be remote from the therapeutic portion and configured to engage a second portion of the subject. The tube may be configured to transfer pressure applied to the reservoir by a movement of the subject from the reservoir to the therapeutic portion.

In accordance with some embodiments, a method for applying a therapeutic treatment to a subject is provided. The method may comprise attaching a therapeutic device to a subject. The therapeutic device may comprise a therapeutic portion, a reservoir, a tube operatively coupling the therapeutic portion and the reservoir, and a working material disposed within the therapeutic portion, the reservoir, and the tube. The therapeutic portion may be configured to engage a first portion of the subject. The reservoir may be remote from the therapeutic portion and configured to engage a second portion of the subject. The method may also comprise applying a pressure to the reservoir through a movement of the subject, wherein the pressure is transferred from the reservoir to the therapeutic portion via the tube, the transferred pressure applying pressure to the first portion of the subject.

### BRIEF DESCRIPTION OF THE DRAWINGS

The features and advantages of the various embodiments will be more fully disclosed in and apparent after reviewing by the following detailed description of the preferred embodiments, which are to be considered together with the accompanying drawings wherein like numbers refer to like parts and further wherein:

FIG. 1 illustrates a partial view of a portion of fabric including a cell pack, in accordance with some embodiments.

FIG. 2 illustrates an exploded view of a cell of the cell pack, in accordance with some embodiments.

FIG. 3 illustrates a wearable garment for positioning over a user's limb, in accordance with some embodiments.

FIG. 4 illustrates a portion of the cell pack network, in accordance with some embodiments.

FIG. 5 illustrates an exploded view of a cell of the cell pack network of FIG. 4, in accordance with some embodiments.

FIGS. 6a-6d illustrate representative pressures of a 3×3 cell pack during use, in accordance with some embodiments.

FIG. 7 is a graph illustrating the change in pressure over time of various cells during movement, in accordance with some embodiments.

FIGS. 8a-8c illustrate an apparatus and process for forming the cell pack in accordance with some embodiments.

FIGS. 9a to 9e illustrate molds in accordance with some embodiments.

FIG. 10 illustrates an embodiment for securing a cell pack in a shape suitable for use with a subject.

FIG. 11 illustrates another embodiment for securing a cell pack in a shape suitable for use with a subject.

FIG. 12 illustrates another embodiment for securing a cell pack in a shape suitable for use with a subject.

FIG. 13 illustrates an embodiment for attaching a securing mechanism to a cell pack.

FIG. 14 illustrates a device for providing a therapeutic stimulus to a subject in accordance with embodiments.

FIG. 15 illustrates another device for providing a therapeutic stimulus to a subject in accordance with some embodiments.

FIGS. 16a and 16b are front and rear perspective views, respectively, of a device attached to a subject in accordance with some embodiments.

FIG. 17 illustrates a therapeutic garment in accordance with some embodiments.

FIG. 18 illustrates another device for providing a therapeutic stimulus to a subject in accordance with some embodiments.

FIG. 19 illustrates another therapeutic garment in accordance with some embodiments.

FIGS. 20a and 20b illustrate another therapeutic garment in accordance with some embodiments.

FIG. 21 illustrates the coupling of interconnecting tubing in accordance with some embodiments.

FIGS. 22a and 22b illustrate the interior cavity of a reservoir in accordance with some embodiments.

FIG. 23 illustrates a valve for adding and removing working material from a therapeutic device or garment in accordance with some embodiments.

FIG. 24 illustrates a reservoir for adding and removing working material from a therapeutic device or garment in accordance with some embodiments.

FIG. 25 illustrates and embodiment of a therapeutic device in accordance with some embodiments.

FIGS. 26a and 26b illustrate therapeutic garments the operable therapeutic components in different locations on the subject in accordance with some embodiments.

FIG. 27 illustrates a therapeutic device integrated with a shoe in accordance with some embodiments.

FIG. 28 illustrates a therapeutic device in accordance with some embodiments.

FIG. 29 illustrates a method of applying a therapeutic treatment to a subject in accordance with some embodiments.

### DETAILED DESCRIPTION

The description of the preferred embodiments is intended to be read in connection with the accompanying drawings, which are to be considered part of the entire written description of this disclosure. The drawing figures are not necessarily to scale and certain features of the embodiments may be shown exaggerated in scale or in a somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship.

As used herein, the term “substantially” denotes elements having a recited relationship (e.g., parallel, perpendicular, aligned, etc.) within acceptable manufacturing tolerances. For example, as used herein, the term “substantially parallel” is used to denote elements that are parallel or that vary from a parallel arrangement within an acceptable margin of error, such as +/−5°, although it will be recognized that greater and/or lesser deviations can exist based on manufacturing processes and/or other manufacturing requirements.

In some embodiments, a material including a network of flexible cells (referred to herein as a “cell pack”) filled with, e.g., a fluid, is disclosed. The network of flexible cells is configured to provide muscle compression, stimulation and/or a massage effect (collectively and individually sometimes referred to herein as “therapeutic stimulus”) to an underlying structure, such as a muscle, in contact with the fabric. For example, the material including the network of flexible cells may be formed into a garment (or portion of a garment) covering a limb of a user. When the user moves a respective limb covered by the cell pack, the fluid or other material within the flexible cells is redistributed due to the local forces applied to the cell pack by the joint or other body part. Redistribution of the material (e.g., fluid) within the flexible cells propagates pressure about the underlying structure, such as a joint and related muscles, providing a passive targeted massage effect to the muscles. Such stimulation and/or massage effect may be used in physical therapy treatment, treatment of pulled muscles, strength training, etc. In some embodiments, the cell pack is integrated into a customizable, wearable device that simultaneously provides resistance and massage stimulation, for example, to promote muscle recovery. In some embodiments, a cell pack is configured to provide controlled compression and exercise of a predetermined set of muscles and/or joints.

In various embodiments, a material including a cell pack is configured to be tightly fit around a portion of a user to provide continuous resistance stimulation. The material may be formed into a wearable garment including one or more portions configured to be tightly fit around one or more predetermined portions of a user, such as, for example, one or more arms, legs, and/or other body portion(s). Portions of the material including the cell pack that cross over and/or interact with a joint (e.g., an elbow or knee joint) provide continuous resistance stimulation to operation of the respective joint during daily use.

The material including the cell pack may be configured to interface with a predetermined portion of a user's physiology. For example, in some embodiments, the material including the cell pack may be formed into and/or integrated with a garment that is configured to partially cover at least a portion of a user's extremity, such as, for example, an arm or a leg. In some embodiments, a garment, for example, a shirt, may include one or more portions including a material having one or more cell pack and portions including a traditional fabric material. In some embodiments, the garment includes a low-profile, smart garment—where the motion of the material within the cell pack (e.g., a fluid or gel), is driven by the muscle contraction and the resulting compression of the cells—configured to be worn under additional clothing or material.

In some embodiments, the material including at least one cell pack is configured to provide targeted stimulation to specific joints and/or muscles. For example, the network of flexible cells may cause a distribution of different pressures placed by the material on the underlying tissue, where the pressures may vary from one part of the material to another. Such variations may be caused by, for example, the materials and particular structures of the network of flexible cells as described herein. The material provides a biomimetic design configured to deliver precise compression and weighting to target portions of a user. The biomimetic design includes a cell-pack configured to provide unique compression similar to that provided by a human circulation system. The combination of biomechanics and fluid mechanics facilitated by the garment is configured to provide precise location of forces to stimulate recovery of underlying physiological elements, such as joints and muscles.

In some embodiments, the material includes a liquid and/or gel weighted material that is contained within a supporting fabric. The supporting fabric and the liquid/gel weighted material provide an array of functional cell packs with a fluid component (e.g. hydrogel, air, etc.) enclosed therein. The cell pack can be made of an elastic stretchable polymer (i.e., elastomer), consisting of a network of hexagonal (in one non-limiting embodiment) compartments that contain the working fluid, connected via channels. The channels may be fibrous. In some embodiments, the material is configured to mimic a smart biological system that changes flow patterns and pressure distribution to handle the demand imposed by the task in which the user is engaged. In some embodiments, the supporting fabric includes spandex, although it will be appreciated that any suitable supporting fabric may be used.

In some embodiments, the array of functional cell packs provides a compression/stimulation mechanism that is analogous to a cardiovascular system, which actively modulates the heart rate and dilation levels in the relevant portions of the arterial tree, supplying the blood flow needs of specific muscle groups. Similarly, the material, using underlying contractions (e.g., muscle contractions) as an input signal, is configured to induce displacement of the compartments' flexible boundaries, initiating a local inter-compartmental flow, thereby building up local pressure as the fluid/gel attempts to move through the highly resistive channels. The channels may be fibrous. As fluid is displaced to other compartments, inner pressure within the array of functional cells increases due to elastic boundaries being stretched. In some embodiments, the increase in inner pressure propagates from a source compartment, mimicking a massage. The material may be configured to provide sufficient extra weight (for example, based on the inclusion of a fluid within the array of functional cell packs) needed for generating beneficial recovery-stimulating resistance, as well as compression and massage that are automatically targeted, for example, at one or more activated muscles underlying the material.

In some embodiments, a material including a cell pack comprising a plurality of cells interconnected by a plurality of connecting channels is provided. The channels may be fibrous. The plurality of cells includes a working material configured to be transitioned from a first cell to at least a second cell when a compressive force is applied.

In some embodiments a material configured to provide therapeutic compression using a plurality of cell packs is provided.

In some embodiments, a material comprising a plurality of cell packs is provided.

In some embodiments, a method of providing therapeutic compression using a material including at least one cell pack is provided.

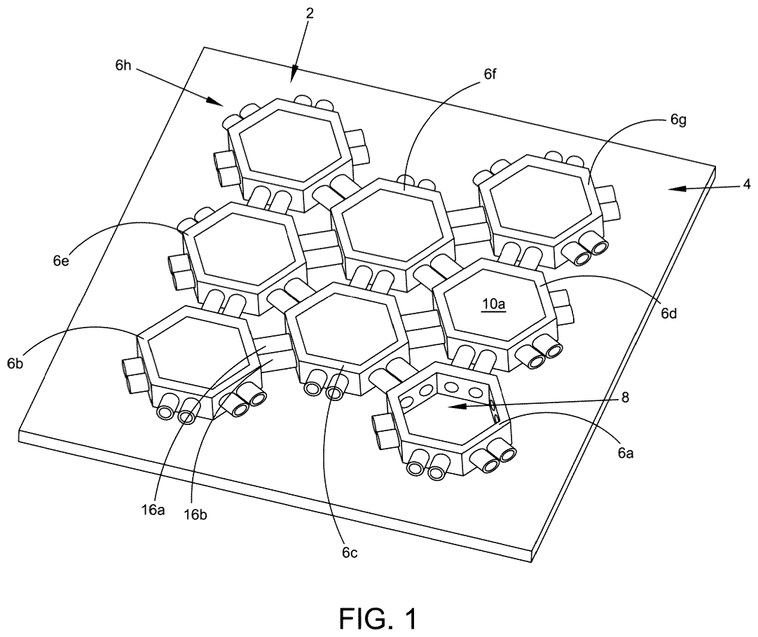

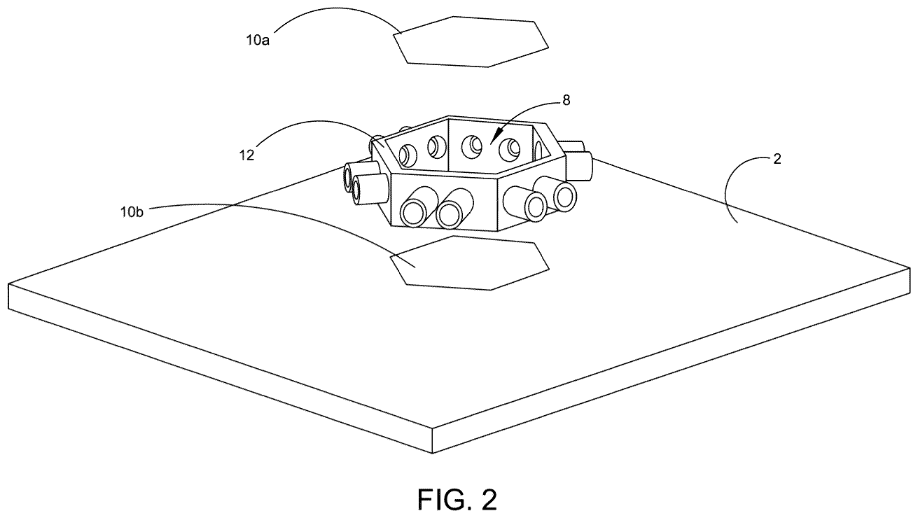

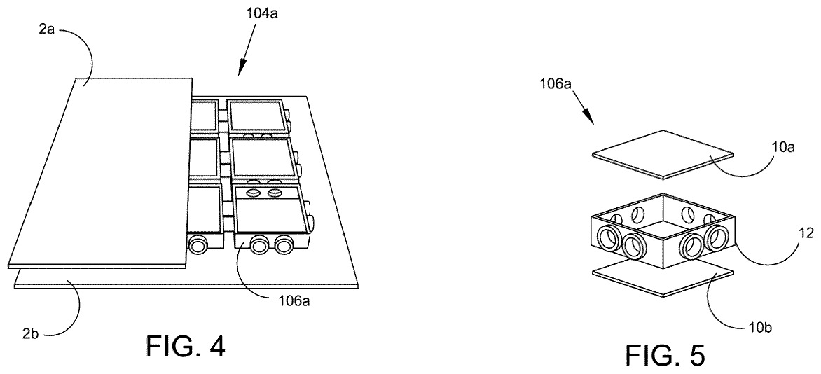

FIG. 1 illustrates a partial view of a portion of material 2 including a cell pack 4, in accordance with some embodiments. FIG. 2 illustrates an exploded view of a cell 6a of the cell pack 4, in accordance with some embodiments. The cell pack 4 includes a plurality of cells 6a-6h (collectively “cells 6”) that each defines an internal cavity 8. The cells 6 include an upper layer 10a, a lower layer 10b, and a perimeter wall 12 that collectively define the internal cavity 8. In some embodiments, one of the upper layer 10a and/or the lower layer 10b includes a material having a first (e.g., higher) elasticity and the perimeter wall 12 includes a material having a lower elasticity (e.g., more rigid). In some embodiments, one of the upper layer 10a and/or the lower layer 10b may be defined by a portion of the material 2, such as a fabric material, suitable for a material contained therein. In some embodiments, the internal cavity 8 is filled with a working material, such as a working fluid and/or gel. In some embodiments, the perimeter wall 12 may define any suitable shape, such as, for example, a hexagonal outer perimeter (as shown), a square outer perimeter (see FIG. 4), a circular perimeter, and/or any other suitable perimeter shape.

Each of the cells 6 is interconnected by one or more connecting channels 16a, 16b (collectively “connecting channels 16” or “channels 16”). The channels may be fibrous. The connecting channels 16 may be formed of the same material (described below) as the perimeter wall 12 of each of the cells 6. In some embodiments, the connecting channels interlink, or knit together, the plurality of cells 6. When one or more of the cells 6 are compressed (e.g., squeezed), for example by a wearer flexing a muscle positioned beneath or adjacent to the respective portion of the fabric 2, pressure build-up displaces the fluid into adjacent cells 6 through the connecting channels 16. The force displacement/build-up of the working material provides therapeutic compression to one or more targeted muscle groups co-located with the fabric 2.

Due to the elastic nature of each cell 6, e.g., the elastic nature of the upper layer 10a and/or the lower layer 10b, the extra working material that is received in each of the cells 6 will raise pressure in those cells, while depressurizing the central compartment. The combined pressurization/depressurization is configured to propagate pressure, for example, giving the patient in contact with the material a feeling of a propagating pressure mimicking a massage. When the pressure is relaxed (e.g., when a muscle is relaxed), the pressure build-up in the adjacent cells 6 pushes the extra working material back into a central, depressurized cell 6, restoring initial equilibrium.

In some embodiments, the flow throughout the entire material 2, e.g., throughout the entire network of cell packs 4, may be simulated using computational fluid dynamics and/or as a first order approximation treating the network of cell packs 4 as a hemodynamic circuit where cells 6 act as capacitors, and the connecting channels 16 as resistors.

In some embodiments, each cell pack 4 may include one or more elastomeric materials, such as, for example, PDMS Sylgard® 184, Ecoflex™, etc. PDMS Sylgard® 184, a silicone elastomer, is available from Dow of the United States, and, and Ecoflex™ is available from Smooth-on, Inc. of the United States. All types of the Ecoflex™, e.g., Ecoflex™ 00-10, 00-20, 00-30, 00-31, etc., may be suitable. Ecoflex™ is a platinum-catalyzed silicone rubber. Sylgard® 184 may consist of different mixing ratio in various embodiments, such as 10:1, 15:1, or 30:1 (elastomer base: curing agent) of when forming the elastomer. In some embodiments, the Sylgard® 184 may have an elasticity modulus of between 1.3-3 MPa. In some embodiments, the Ecoflex™ may have an elasticity modulus of 0.05-0.125 MPa. The various material properties, such as the elasticity of modulus, can be varied in order to provide a particular targeted treatment.

The use of elastomeric materials provides tunable mechanical strength and surface properties to each of the cells 6. The properties of the elastomer (e.g., elastomeric material), such as elastic modulus, may be adjusted to change fluidic resistance and the pressure distribution across different cells 6. The surface properties of the elastomer also influence its attachment with the supporting fabric 2.

In some embodiments, the elastic modulus of an elastomer material, such as Sylgard 184 (30:1-5:1) or Ecoflex (00-10 to 00-50), or SE1700 (10:1-1:1), is controlled by a ratio between a monomer and a curing agent and is also controlled by the mixed portion of these materials. In some embodiments, the composition of the working material, such as a hydrogel, may be selected to further adjust the properties of an elastomer with respect to the geometry of the functional cell pack 4 to affect pressure redistribution within the cell pack 4 when stimulated by muscle contraction. In some embodiments, the surface properties of an elastomer (e.g., a polymer, or an elastomer material) can be selected to provide adhesion between the functional cell pack 4 and the supporting fabric 2.

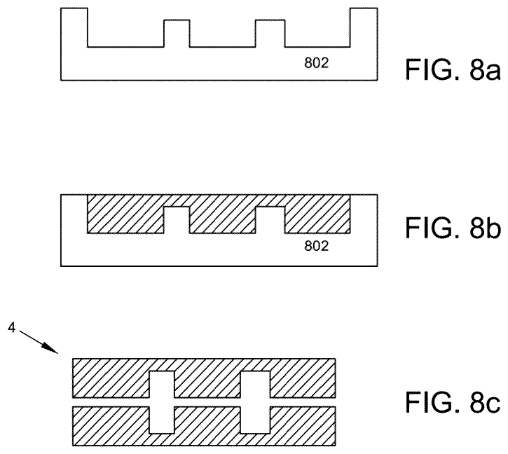

In some embodiments, a garment may include a material 2 may be manufactured by bringing together two halves of a cell pack 4 that are joined together, such as that described below with respect to FIGS. 8a-8c. Each half of the cell pack 4 may be formed through any suitable method, such as, for example, cast molding. In some embodiments, oxygen plasma treatment may be used to activate jointing surfaces. In other embodiments, fresh elastomers may be used as glue to join the two half pieces to define a full garment.

FIGS. 8a-8c illustrate an apparatus and process for molding/forming the cell pack 4 in accordance with some embodiments. The molding may begin with a mold 802 that has been appropriately shaped to create the cell pack 4 required. In other words, the size of the internal cavity 8, shape of the cells 6, number and shape of the channel(s) 16 are determined by the mold. Next, the appropriate compounds/materials are put into the mold and cured, as is known in the art, to form one half of the cell pack 4, as shown in FIG. 8b. Once the two-halves of the cell pack 4 are formed and removed from the mold 802, as shown in FIG. 8c, they may be joined together as described herein. In some embodiments, the size of each of the cells 6 and/or the connecting channel(s) 16 can be varied. In some embodiments, the diameter of each of the connecting channel(s) 16 may be sized from about 0.3 mm to about 3 mm. The size of the connecting channel(s) 16 may be selected to control flow resistance across the connecting network. In some embodiments, a surface of an elastomer can be modified using an oxygen plasma process to tailor adhesion with the supporting fabrics.

In some embodiments, the molding/forming of the cell pack 4 may be an iterative process. For example, portions of the cell pack 4 having common composition may be formed at the same time. Once that portion has cured, other portions of the cell pack 4 having different properties or made of different materials may be formed and allowed to cure. Other processes may be used to form the cell pack 4 such that it is made of different materials and/or has varying processes, for example, using 3D printing.

In some embodiments, each of the cells 6 and/or the connecting channel(s) 16 may be formed by a 3D printing process. For example, the cells 6 and/or the connecting channels 16 may be formed directly by 3D printing. As another example, a 3D printing mold may be generated using any suitable additive manufacturing process, such as, for example, a QIDI Technology Dual head 3D printer available from QIDI Technology of China.

In various embodiments, the dimensions of the cell pack 4 are selected to provide predetermined fluidity, viscosity, and/or applied pressures. The viscosity may be selected to provide a Newtonian or non-Newtonian response. In some embodiments, a non-Newtonian response and resistance to temperature change are provided by a bio-safe hydrogel, or slime. For example, in some embodiments, a working material may include a material having water, polyvinyl alcohol, borax, e.g., Na₂B₄O₇·10H₂O, or any other fluid of suitable viscosity for the desired resistance to flow, e.g., glycerin, lubricating oil, etc. A non-exhaustive range of viscosities includes 0.85-954 mPa-s where, again, the various material properties, can be varied in order to provide a particular targeted treatment through designed fluid flow and distribution of pressures across a cell pack 4. For example, water may have a viscosity of between 0.85-0.95 mPa-s and, e.g., Glycerin 954 mPa-s.

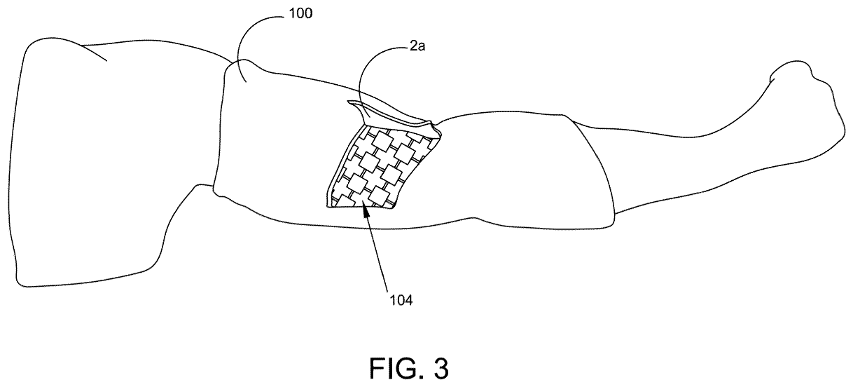

FIG. 3 illustrates an embodiment of wearable garment 100 configured for positioning over a user's limb, for example, an upper arm (e.g., bicep, triceps, etc.) and elbow joint. In embodiments, the wearable garment 100 may be a sleeve. A portion of an upper layer 2a of the garment 100 is removed to illustrate the cell pack network 104 therein. The cell pack network 104 includes a plurality of cell packs 4 similar to the cell packs 4 and cells 6 discussed above with respect to FIGS. 1-2 (and elsewhere), and similar description is not necessarily repeated here. FIG. 4 illustrates a portion of the cell pack network 104 and FIG. 5 illustrates an exploded view of one cell 106a of the cell pack network 104, in accordance with some embodiments. The cell pack network 104 and the cell 106a are similar to the cell pack 4 and cells 6 discussed elsewhere, and similar description is not repeated here.

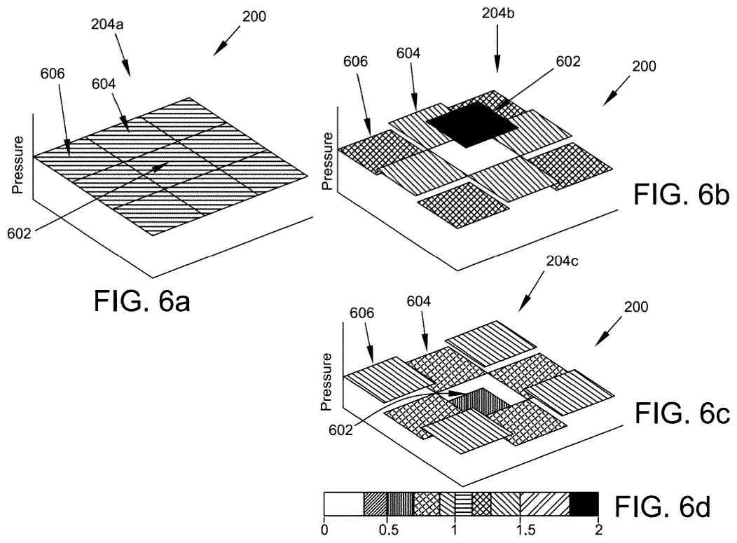

FIGS. 6a-6c illustrate representative pressures of a 3×3 cell pack 200 during use, in accordance with some embodiments. FIG. 6d illustrates a key of various pressures range from lowest (left) to highest (right). FIGS. 6a-6c indicate transitions between various pressure states, for example, due to movement of a muscle or compression of various cells within the 3×3 cell pack. In some embodiments, FIGS. 6a-6c illustrate a chronological transition of a garment including the 3×3 cell pack 200. As shown in FIG. 6a, in some embodiments, the 3×3 cell pack 200 starts in a neutral state 204a before a central cell 602 is compressed, increasing pressure within the cell 602 as illustrated by FIG. 6b. This pressure increases in cell 602 and causes the working material within the cell 602 to move to the surrounding cells, e.g., cells 604 and 606, causing the cell pack 200 to be in state 204b. Upon release of the force that compressed cell 602, pressure in the other cells, for example 604 and 606, may cause the flow of the working material back to cell 602. In some embodiments, if cell 602 is expanded by, for example, adherence to a moving subject, this may create a negative pressure in cell 602 relative to the adjacent cells, shown in state 204c of FIG. 6c. When compression is removed from the central cells 602, the vacuum within the central cell 602 causes the working material to flow back into the central cell 602, returning the cell pack 200 to an equilibrium, or neutral, state 204a of FIG. 6a.

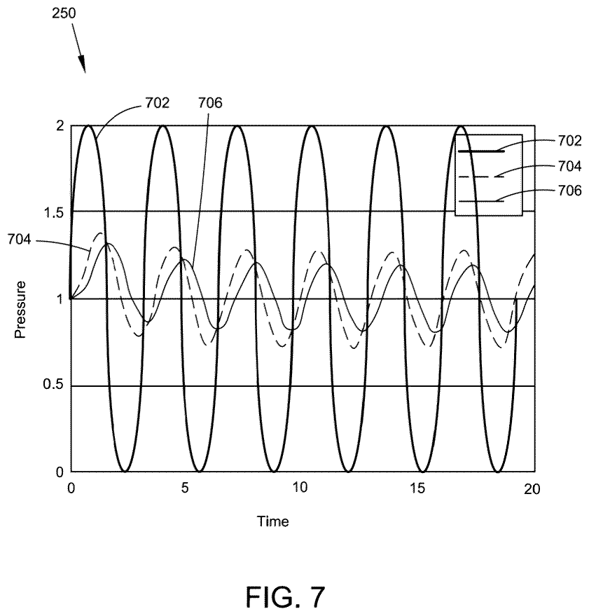

FIG. 7 is a graph illustrating the change in pressure over time of various cells 602 to 606 during repeating movement, with lines 702, 704 and 706 corresponding to the cells 602, 604 and 606, respectively.

The disclosed material may be used in methods of continuous stimulation for assisting in physical recovery, according to some embodiments. A user, such as a patient involved in physical therapy, a patient recovering from a muscle pull, an athlete looking for additional resistance training, a patient looking to enhance microvascular circulation etc., may be instructed to wear a garment including a material having one or more cell packs, for example, including positioning of one or more tightly-fitting sections around selected muscle and/or joint locations. As the user engages in activities, such as normal movement during the day, the material, and specifically the cell packs, exerts targeted compressive force on the predetermined portions of the body (e.g., joints, muscle groups, etc.) that stimulates recovery.

In some embodiments, the disclosed material may be formed using a hybrid manufacturing process, including, but not limited to, cast molding, 3D printing and plasma treatment, configured to generate a network of flexible cells filled with a viscous Newtonian or non-Newtonian fluid. The network of flexible cells provides tunable fluid dynamics and responsive material designed to aid in recovery and stimulation of targeted physiological features.

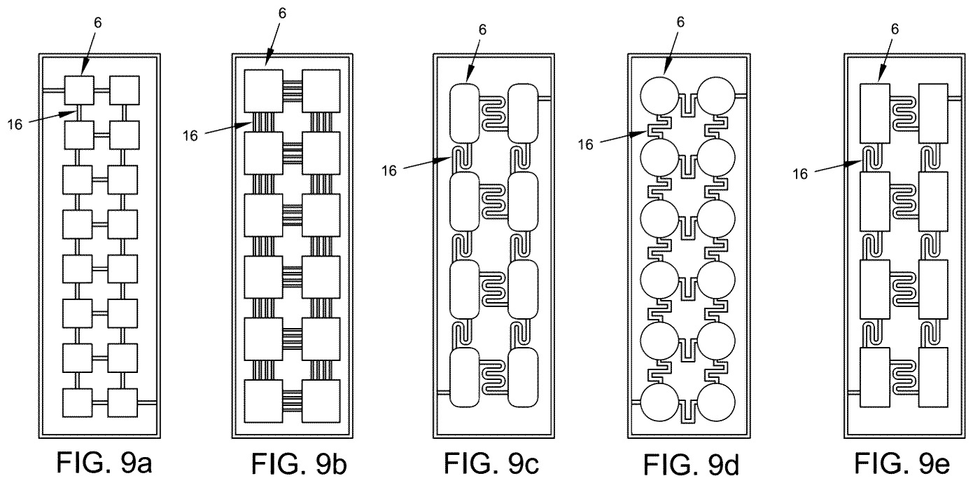

In various embodiments, cell pack 4 may comprise the required shape (round, square, rectangular, etc.), number, distribution (e.g., a rectangular grid with 10-20 mm cell spacing, staggered over a, e.g., 150-250 mm×50 mm cell pack, including sizes of 150×50 mm (particularly useful for artificial muscles), 190×50 mm, 200 mm×50 mm, and 250 mm×50 mm), and size of both cells 6 (e.g., 5-8 mm radius, 10-20 mm in length/width for rectangular and square shapes, including 15×15 mm, and 10×20 mm seizes, using a depth of between 1-2 mm for any shape) and channels 16 (e.g., 1-5 between cells having a total length between 25-55 mm, using, e.g., a 1×1 mm cross-section for square shapes, 0.5 mm radius for round shapes, or varying cross-section by decreasing then increasing the cross area) in order to provide the required, targeted stimulation to the subject. In one example, a channel diameter of 1 mm was used with cell spacing of 10 mm on a short-side pitch and 20 mm on the long side pitch, with cells of 2 mm height and a volume of 157.5 mm³. These characteristics, along with the particular materials, may be designed to control the effective fluidic resistance of the cells 6, both as a group and individually, thereby increasing or decreasing the pressure required for the working material to flow between cells or particular cell. These variable pressures in turn result in varying pressures delivered to different locations on the subject. Various embodiments that may have these characteristics are shown in FIGS. 9a to 9e that illustrate the mold 802, that may be 3D printed, used to form the cell pack 4. For example, FIGS. 9a to 9b illustrate square cells 6 each with either one or three channels 16 connecting them, respectively. FIG. 9c illustrates an elongated cell 6, which may be substantially rectangular and/or ovoid in shape, with rounded, serpentine channels 16, where the tortuous fluid path created by the many extensions and returns may increase the resistance to fluid flowing from one cell 6 to another. FIG. 9d illustrates yet another shape for both cell 6 and channel 16. For example, the cell 6 may be substantially spherical or, as viewed, a cylinder extending into and out of the page. Channels 16 may also be serpentine, like the channels 16 of FIG. 9c, albeit with squared corners. As illustrated in FIG. 9e, cells 6 may be cuboid and/or as viewed, a cylinder with its height running from the bottom to the top of the page.

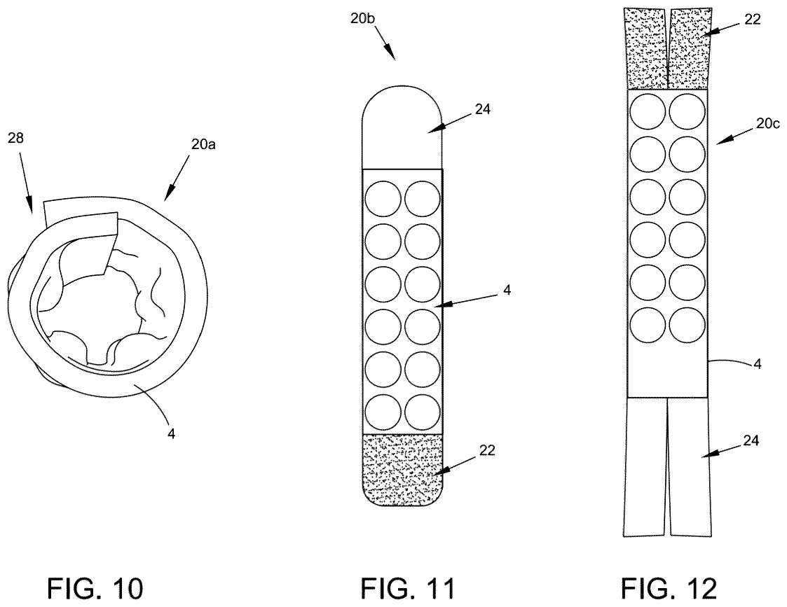

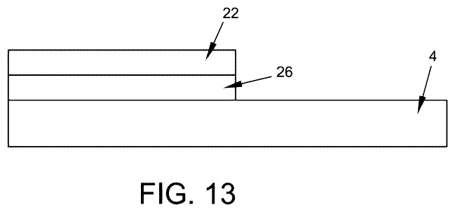

FIGS. 10-12 illustrate various embodiments for securing a cell pack 4 in shape such that it may envelop, or wrap, a portion of a subject in accordance with some embodiments. For example, the device 20a of FIG. 10 shows the cell pack 4 folded over and secured to itself at location 28 using glue or other fusing technique described herein or otherwise known to a person of ordinary skill. As shown in FIG. 11, device 20b uses hooks 22 and loops 24 coupled to the cell pack 4 for the releasable securing the cell pack 4 in the desired shape and orientation, for example, wrapping around an extremity of a user. Device 20c of FIG. 12 is yet another design incorporating hooks 22 and loops 24, albeit with two separate sections to provide increased angles and directions in which the device 20c may be secured in the desired shape. As illustrated in FIG. 13, the hook 22 (or loops 24, not shown) may be attached to the cell pack 4 via a fabric iron patch 26, which may provide for a more robust and effective coupling and between the cell pack 4 and hooks 22 (or loops 24) when cell pack 4 is composed of materials such as those described herein. Each of these embodiments may be paired with the fabric material 2 to cover all or a portion of the cell pack 4 as described earlier.

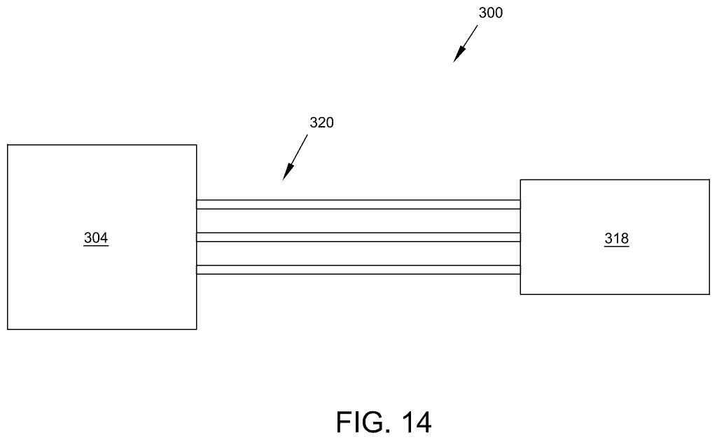

FIG. 14 illustrates a device 300 for providing a therapeutic stimulus to a subject (not shown) in accordance with some embodiments. Device 300 comprises a therapeutic portion 304, reservoir 318, a plurality of tubes/fluid conduits, such as tubes 320. The therapeutic portion is configured to engage a first portion of the subject. For example, the first portion may be a muscle (calf, thigh, etc.) or joint (knee, ankle, etc.). The therapeutic portion 304 may be a cell pack, e.g., one of the various described above or elsewhere herein. The therapeutic portion 304 may be configured to provide a therapeutic pressure, stimulus, or massage to the engaged first portion.

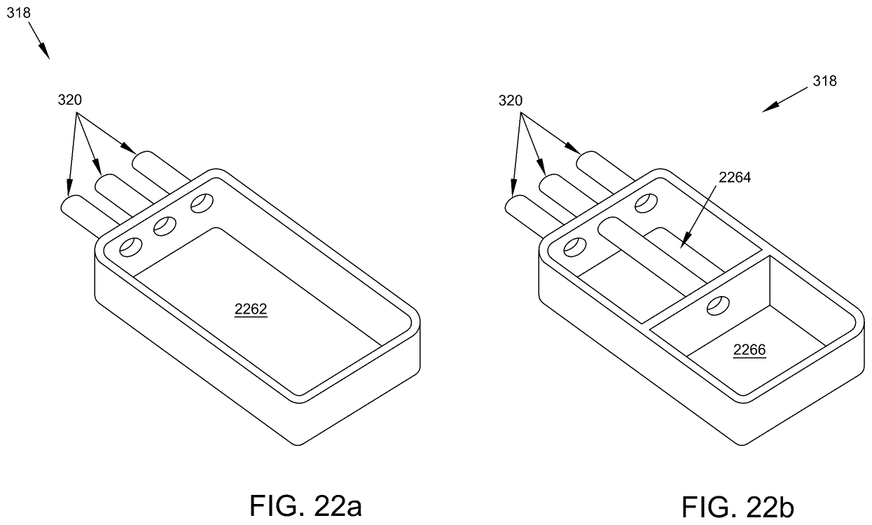

Reservoir 318 may be remote from therapeutic portion 304 and is configured to engage a second portion of the subject. For example, the second portion may be a foot, posterior, or joint. As illustrated in FIGS. 22a-22b, reservoir 318 may comprise one or more internal cavities filled with a working fluid. This internal cavity(ies) is compressed during the subject's movement. This may occur, e.g., when subject walks, runs or is lifting weights, causing more pressure to be applied through the subject's foot. Similarly, pressure on a reservoir 318 can be applied by the movement of joint when, e.g., the reservoir is forced to stretch around the joint as the subject moves. Similarly, the reservoir may be compressed by the subject sitting. This compression applies a pressure to the working fluid in the internal cavity(ies) of reservoir 318 causing a pressure increase. This pressure increases in the internal cavity results in the pressure and/or a fluid flow propagating from the reservoir 318 to one or more of the tubes 320. In turn, this propagated pressure and/or fluid flow travels through the tubes 320 to the therapeutic portion 304, causing a therapeutic pressure, stimulus, or massage to the subject, e.g., as described for the above cell packs. A difference between the cell packs described above and the therapeutic device 300 is that the source of the pressure and/or fluid flow to the effected muscle may be remote from that muscle.

As described above, one or more tubes 320 provided for the transfer of pressure and/or fluid flow from the reservoir 318 to the therapeutic portion 304 in response to movement of the subject. Similarly, tubes 320 provide for the flow of fluid from the therapeutic portion 304 to the reservoir to, e.g., relieve the increase in pressure from the therapeutic portion 304. This may occur when, e.g., the subject's foot lifts off the ground, the user sets down weight, stands up from seated position, or straightens a joint. Tubes 320 are configured to allow the transfer of the pressure and/or fluid because they are operatively coupled to the therapeutic portion 304 and reservoir 318.

Disposed within tubes 320, therapeutic portion 304, and reservoir 318 is a working material. The working material may comprise, e.g., hydrogel, a composition of water, polyvinyl alcohol, and borax, or other compositions of the working material as discussed above. The working material serves as an efficient means for transporting the energy associated with the compression of the internal cavity(ies) of reservoir 318 to the therapeutic portion 304.

As described above, device 300 is able to passively provide a therapeutic pressure, stimulus, or massage to the subject. The therapeutic pressure, stimulus, or massage to the subject is passively provided because the device can use the movement of the subject intended to achieve something other than the therapeutic pressure, stimulus, or massage (e.g., walking, running, exercise, sitting, stretching) to the subject in order to provide the therapeutic pressure, stimulus, or massage to the subject.

Each of the therapeutic portion 304, reservoir 318, and tubes 320 may comprise one or more elastomers, e.g., the elastomers described above for the above cell packs. Like the above-described cell packs, therapeutic portion 304, reservoir 318, and tubes 320 may each have specifically chosen materials and/or material properties in order to provide a targeted therapeutic pressure, stimulus, or massage to the subject and/or for their particular role. For example, a softer and/or more flexible material may form a portion of the reservoir 318 for engaging the second portion of the subject to provide a more comfortable fit, while a second portion of the reservoir 318 (e.g., an outer portion) may be harder and/or stiffer to better transfer energy to the therapeutic portion. As another example, the stiffness of tubes 320 may be prioritized so that less energy is lost from expansion of the tube 320 walls during the transfer of the pressure and/or fluid. In one example, tubes 320 may comprise a relatively rigid material with flexible links between different relatively rigid sections of the tube 320 to account for the motion of subject while having no appreciable change in dimensions resulting from the transfer of pressure and/or fluid flow therethrough. Therapeutic portion 304 may comprise the variety of materials as described above with respect to the cell packs.

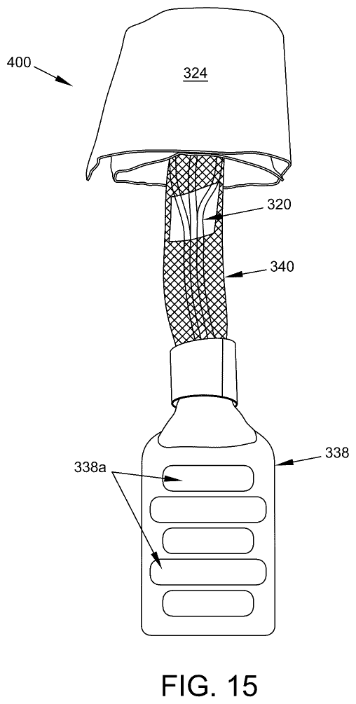

FIG. 15 illustrates a device 400 for providing a therapeutic stimulus to a subject in accordance with embodiments. Device 400 may comprise device 300 enveloped in, or surrounded by other materials such that the other materials are located between device 300 and the subject and/or other objects. For example, device 300 may comprise the working portions of device 400 which may not, depending on their exact composition and structure, be desirable for direct engagement with the subject, the subject's clothing, or objects around or near the subject. For example, material 340 may be placed around tubes 320 gather them into a bundle. Gathering the materials in this way may make the device more comfortable to wear, may fit better underclothing, and/or be less likely to catch tubes 320 on external objects. As shown in FIG. 15, material 340 surrounding tubes 320 may be a mesh material.

Similarly, therapeutic portion 304 may be covered in a material 324. Example of material 324 include spandex, lycra, cotton, etc. Material 324 may also be other smooth materials and/or otherwise selected to optimize the subject's experience during direct engagement (i.e., touching) of the therapeutic portion 304 with the subject's skin or clothing. Additionally, the material may be formed with and in the manner as described above in FIGS. 10-13 for tightly fitting and securing the therapeutic portion 304 at and/or around the desired portion of the subject.

Reservoir 318 may similarly be surrounded by material 338. Material 338 may comprise the particular materials as described above for material 324. Additionally, a portion 338a of material 338 may be, e.g., a non-skid material in order to minimize relative motion between the reservoir 318 and the portion of the subject with which it is engaged. For example, reservoir 318 may slide within a subject's shoe, particularly, if both the material 338 and the subject's socks are smooth, which could lead to discomfort and/or less effective transfer of pressure and/or fluid from the reservoir 318 to the therapeutic portion 304. Non-stick material used for portion 338a may help reduce or eliminate this relative motion.

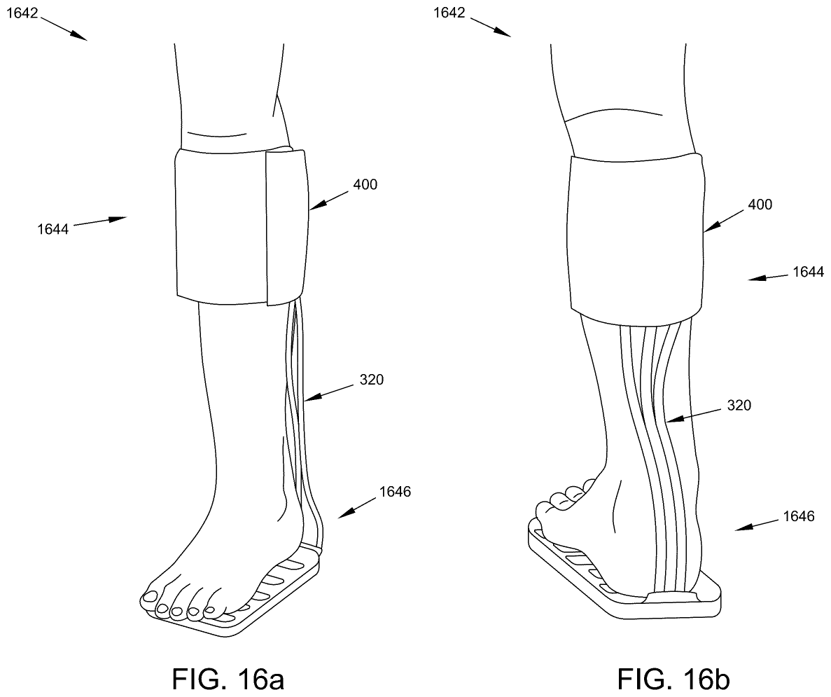

FIGS. 16a and 16b are front and rear perspective views, respectively, of device 400 attached to a subject 1642 in accordance with some embodiments. As can be seen in FIGS. 16a-16b, a portion of device 400 having therapeutic portion 304 is engaged with a first portion 1644 of subject 1642 and reservoir 318 is engaged with a second portion 1646 of subject 1642. In this example, first portion 1644 is one of the subject's limbs and, more specifically, the calf muscle of subject 1642. In some embodiments, first portion 1644 may be another muscle group (e.g., thigh) or joint. Second portion 1646, as shown, is positioned to engage an extremity, such as the foot of the subject 1642. In some embodiments, second portion 1646 may be in other locations, e.g., around a joint, under the subject's posterior, armpit, etc.

The reservoir 318 of device 400 may have a shape and/or size that follows, contours to, or mimics, the portion 1646 of subject 1642 to which it engages. For example, it may be generally oval or circular, or it may be generally trapezoidal, following the general shape of a foot. Reservoir 318 may be sized and shaped in such a manner to increase comfort of the user, to precisely position the reservoir 318 for maximum compressive effect during different movements (e.g., running vs. walking), or to determine when the compressive effect occurs in the movement. For example, a reservoir 318 configured to engage a heal will deliver the therapeutic pressure, stimulus, or massage to the subject when the heal strikes the ground, whereas a reservoir 318 configured to engage the ball of the foot or the toes would deliver the therapeutic pressure, stimulus, or massage to the subject when the foot pushes off, e.g., the ground.

In accordance with some embodiments, therapeutic portion 304 and/or reservoir 318 are configured to engage a predetermined portion of the subject. For example, therapeutic portion 304 may be specifically sized and portioned to fit a particular muscle or muscle group (calf, thigh, etc.) or joint (e.g., knee) for a general adult, adolescent or child. Similarly, reservoir 318 may be specifically sized and portioned to fit a particular portion of the subject (foot, joint, posterior) for an adult, adolescent, or child. In accordance with some embodiments, therapeutic portion 304 and/or reservoir 318 are built such that they are customized to fit a particular portion of a particular subject. therapeutic portion 304 and/or reservoir 318 may be built by, e.g., 3D printing of a mold representative of the subject to which the therapeutic portion 304 and/or reservoir 318 are formed.

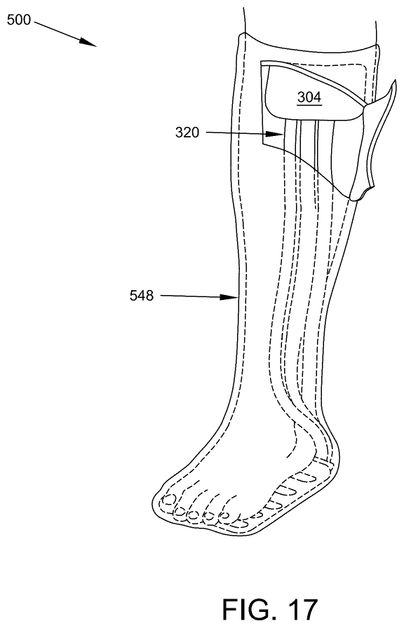

FIG. 17 illustrates a therapeutic garment 500 in accordance with some embodiments. Garment 500 may comprise therapeutic portion 304, reservoir 318 and tubes 320 like in device 300, discussed above. Additionally, Garment 500 may further comprise a material 548 that is coupled to and extends between one or more of the therapeutic portion 304, reservoir 318 and tubes 320. Material 548 may comprise materials like those discussed above with respect to FIG. 15. Therapeutic portion 304, reservoir 318 and tubes 320 may be adhered to, sewn into, or otherwise coupled to the material 548. When formed, therapeutic garment 500 may form, as shown, a sock. However, therapeutic garment 500 may also be formed into sleeves, leggings, body suit, etc. In some embodiments, garments, e.g., garment 500, and/or therapeutic devices are configured to fit tightly against the subject.

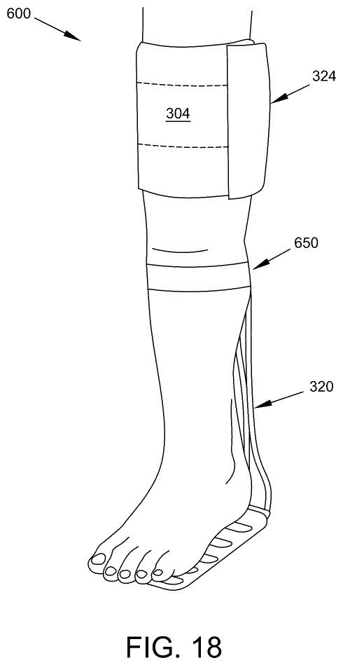

FIG. 18 illustrates another device 600 for providing a therapeutic stimulus to a subject in accordance with some embodiments. Device 600 may be generally similar to device 400, described above, except that that device 600 also contains a strap 650. Strap 650 helps maintain the tubes 320 in close proximity to the subject, and in a more consistent position, particularly as the subject moves. Strap 650 reduces the changes in the relative position of the tubes 320 and subject and may allow the tubes 320 to more closely follow, e.g., the limb of the subject. Strap 650 may also help assist tubes 320 in moving around a joint by providing a pivot point near the joint, such as being closely located to the knee as illustrated in FIG. 18.

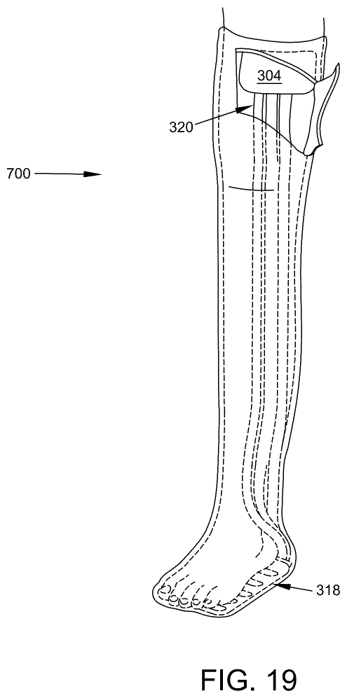

FIG. 19 illustrates another therapeutic garment 700 in accordance with some embodiments. Therapeutic garment 700 may be generally similar to device 500 described above with respect to FIG. 17, however, therapeutic garment 700 is configured to place the therapeutic portion 304 above the knee.

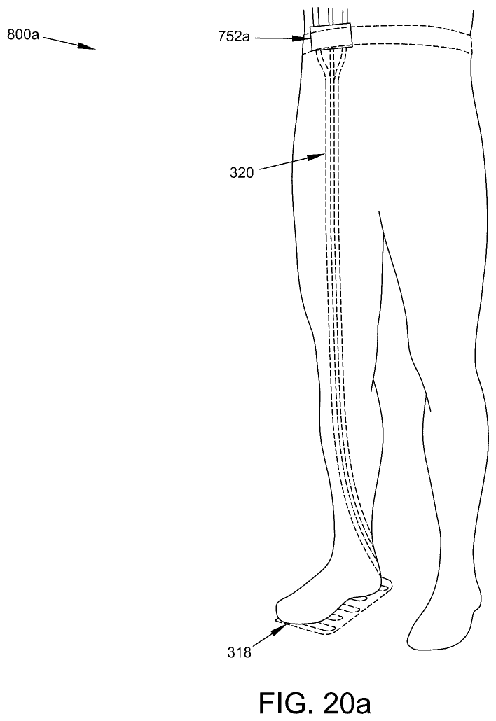

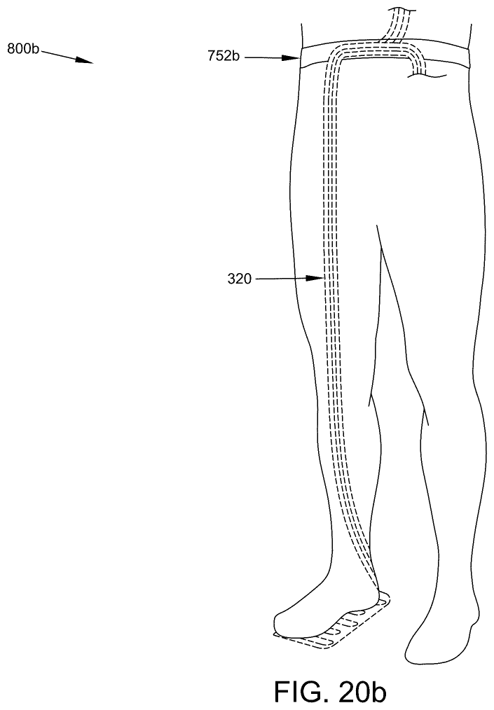

FIGS. 20a and 20b illustrate another therapeutic garment 800a, 800b, respectively, in accordance with some embodiments. For therapeutic garment 800a/800b, tubes 320 are routed to the subject's waist. Because a belt or waist band could compress tube 320, which may lessen or prevent the transfer of pressure and/or fluid from reservoir 318 to therapeutic portion 304, therapeutic garment 800 contains a rigid portions 752a and 752b that may be stronger and/or more rigid than tubes 320 and are configured to prevent the collapse of the same. As shown in FIG. 20a, rigid portion 752a has a width that is approximately the same as the combined width of the tubes and height sufficient to prevent tubes 320 from collapsing due to the belt, waistband, etc. As also shown, tubes 320 exit from rigid portion 752a above the subject's waist. Tubes 320 may then be routed to the targeted portion of the subject using various aspects of the embodiments described herein.

FIG. 20b illustrates rigid portion 752b again having a height sufficient to prevent tubes 320 from collapsing due to the belt, waistband, etc. but also wrapping around a greater portion, or all, of the subject's waist. As shown in FIG. 20b, rigid portion 752b has a belt-like appearance, though other designs can be used. Such a design may be used to route tubes 320 from one side of the subject to another. This routing may aid, e.g., providing the therapeutic pressure, stimulus, or massage to the opposite side of the subject. For example, a subject could step down with their right foot while the therapeutic pressure, stimulus, or massage effect is delivered to the subject's left leg.

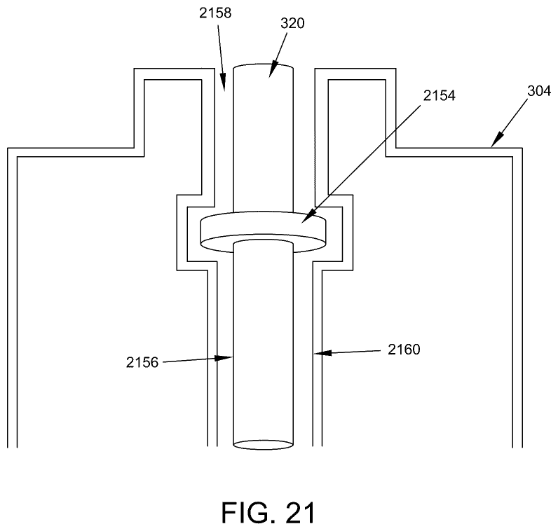

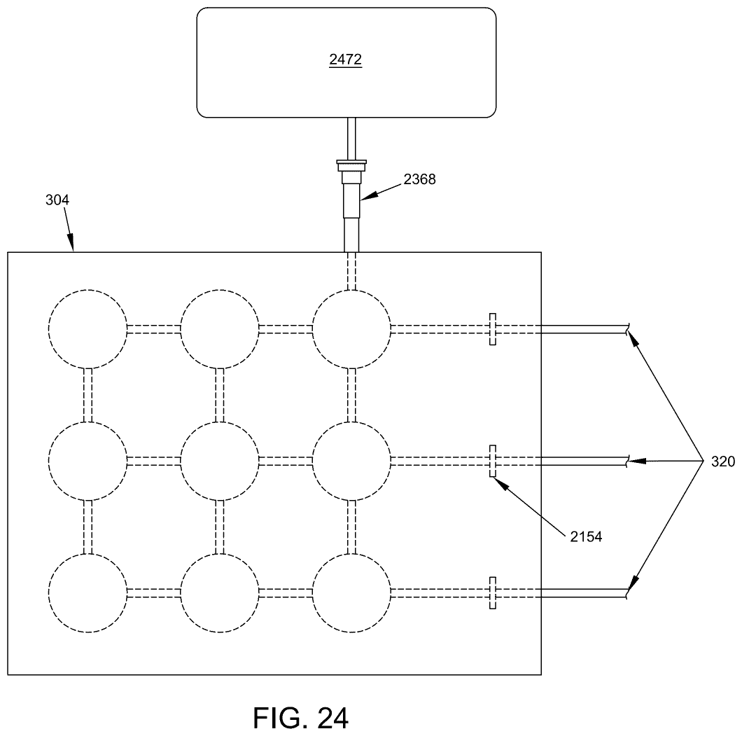

FIG. 21 illustrates the coupling of interconnecting tubing 320 in accordance with some embodiments. Tubing 320 may be coupled to the therapeutic portion 304, reservoir 318, or other component to which tubing may be coupled, such as reservoir 2472 described with respect to FIG. 24. As shown, tubing 320 may comprise an O-ring 2154 configured to prevent and/or minimize working fluid from escaping the therapeutic portion 304, reservoir 318, or other components. Additionally, tubing 320 may have a roughed surface 2156 configured to interface with an interior surface of the therapeutic portion 304, reservoir 318, or other components. Surface 2160 may be similarly roughened. By roughening the surfaces 2156 and/or 2160, a larger contact may be formed between the tubing 320 and therapeutic portion 304, reservoir 318, or other component, creating a more tortuous path for any escaping working fluid, leading to a better seal. Tubing 320 may be inserted into an opening 2158 in the therapeutic portion 304, reservoir 318, or other components and may be frictionally secured thereto. In some embodiments, an adhesive may be used to secure the connection between tubing 320 and the therapeutic portion 304, reservoir 318, or other components. In some embodiments, tubing 320 may be mechanically coupled to the therapeutic portion 304, reservoir 318, or other components using a male-female threaded or press-fitting, hose clamps, or other means. Tubing 320 may be removably coupled to the therapeutic portion 304, reservoir 318, or other components.

FIGS. 22a and 22b illustrate the interior cavity of a reservoir 318 in accordance with some embodiments. For example, in FIG. 22a, reservoir 318 contains a single, large internal cavity 2262. In FIG. 22b, reservoir 318 contains two internal cavities 2264 and 2266. Using two cavities may allow for a different therapeutic pressure, stimulus, or massage effect in that the respective cavities of the reservoir 318 may be compressed at different times and at different rates during movement of the subject. For example, cavity 2264 may be placed under the heel of the subject and be maximally compressed when the heel strikes the ground. Conversely, cavity 2266 may be placed under the ball or toes of the foot and may be compressed more when the foot pushes off the ground. As shown, each cavity 2264 and 2266 may be individually coupled to one or more of the tubes 320 to concentrate the transmission of pressure and/or fluid to the therapeutic portion 304. In some embodiments, tubing may be directional, having one or more tubes transmitting the pressure and/or fluid to the therapeutic portion 304 and one or more tubes returning the pressure and or fluid to the reservoir 318. This directionality may be achieved using, e.g., one-way valves either in the tubing 320 and/or at the connection points of the tubing 320 and the therapeutic portion 304 and/or reservoir 318. These supply and return lines may be combined at some point between the reservoir 318 and therapeutic portion 304 such that that transmitted pressure and/or fluid travels toward the same part (e.g., cells) of the therapeutic portion 304. In some embodiments, the tubing 320, internal cavities (e.g., 2264 and 2266), and parts (e.g., cells) of the therapeutic portion 304 may form separate, isolated fluid circuits from one another.

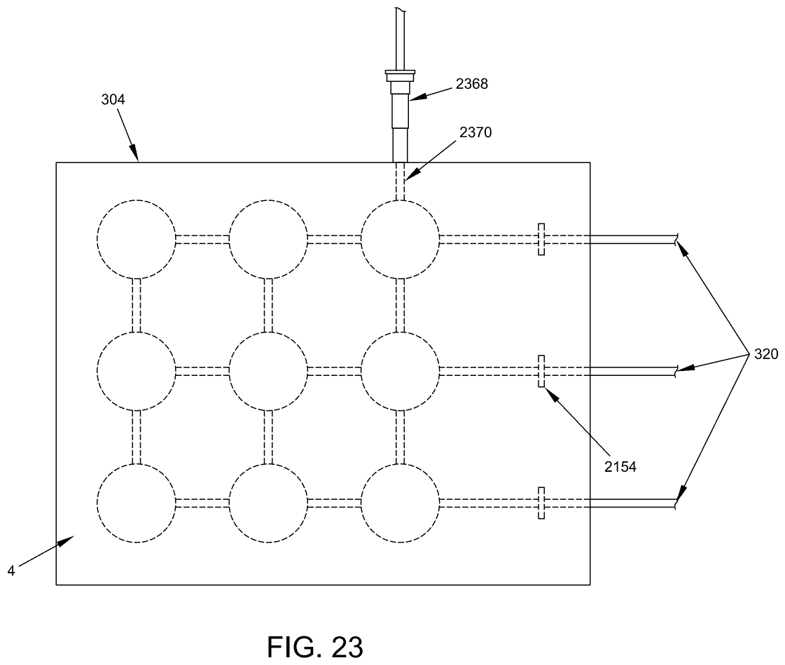

FIG. 23 illustrates a valve 2368 for adding and removing working material from a therapeutic device or garment in accordance with some embodiments. The valve 2368 may be inserted near a side or edge of a component of the therapeutic device or garment, such as the therapeutic portion 304, one or more of the tubes 320, and/or the reservoir 318. As shown in FIG. 23, the valve 2368 is placed near an edge of the therapeutic portion 304. The valve may be coupled to a line 2370 inside the therapeutic portion 304 that leads to one or more cells of the cell pack, e.g., cell pack 4. Valve 2368 is operable to allow for working material, like that described above, to be added to or removed from the therapeutic device or garment. Adding more working fluid will result in higher pressures, while removing fluid will result in lower pressures during movement of the subject. Moreover, one working fluid can be swapped for another working fluid to allow for different therapeutic affects and/or having different fluid properties. Thus, a user is able to have some control over the intensity of therapeutic pressure, stimulus, or massage effect. In some embodiments, a pressure sensor may be used to determine the pressure of the working fluid in the therapeutic device or garment. Valve 2368 may be a multiple position value having different positions for adding, removing, and retaining the working fluid. In some embodiments, Valve 2368 may be replaced by two separate valves, each one-way valve for adding or removing the fluid.

FIG. 24 illustrates a reservoir 2472 for adding and removing working material from a therapeutic device or garment in accordance with some embodiments. The device shown in FIG. 24 is substantially the same as the device shown in FIG. 23 with valve 2368, as described above, operable connected to a reservoir 2472. With valve 2368 in a closed position preventing the flow of working material to and from the reservoir 2472, the working material in the reservoir 2472 is not subjected to the transmission of pressure and/or fluid between the therapeutic portion 304 tubes 320, and reservoir 318. The subject may open valve 2368 to transfer working material between the reservoir 2472 and the working portions of the device (e.g., therapeutic portion 304, tubes 320, and reservoir 318). The reservoir 2472 and valve 2386 could also be combined into one part, for example, a hand-press TPU air inflation valve with a nozzle. By applying an external pressure, the subject can determine the amount of fluid in the operable portions of the device to control the intensity of the transmitted pressure and/or fluid flows.

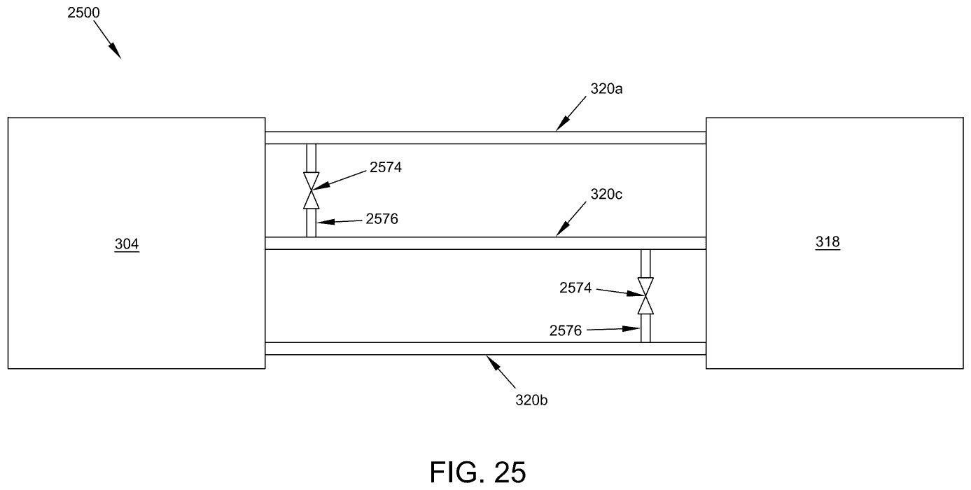

FIG. 25 illustrates and embodiment of a therapeutic device 2500 in accordance with some embodiments. Device 2500 may comprise therapeutic portion 304, reservoir 318, and tubes 320 as described above. Device 2500 may additionally have additional return lines 2574 located between tubes 320. Return lines 2574 may have a valve 2576 located in each for opening and closing, in the full or part, the fluid pathway in each return line 2574. By opening, in full or part, valve 2576, the user may create a hydraulic short in which pressure and/or fluid is directed away from the therapeutic portion 304 to return to reservoir 318. This may be accomplished by having tubes 320a and 320b configured as one-way tubes to supply fluid and/or pressure to the therapeutic portion, and line 320c a one-way tube returning fluid and/or pressure to the reservoir 318. Thus, a user may be able to control the intensity of the therapeutic pressure, stimulus, or massage effect without changing the amount of working fluid in the device 2500.

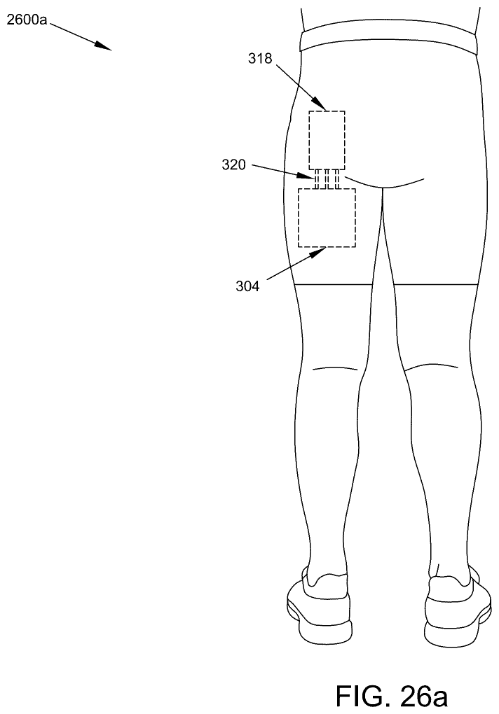

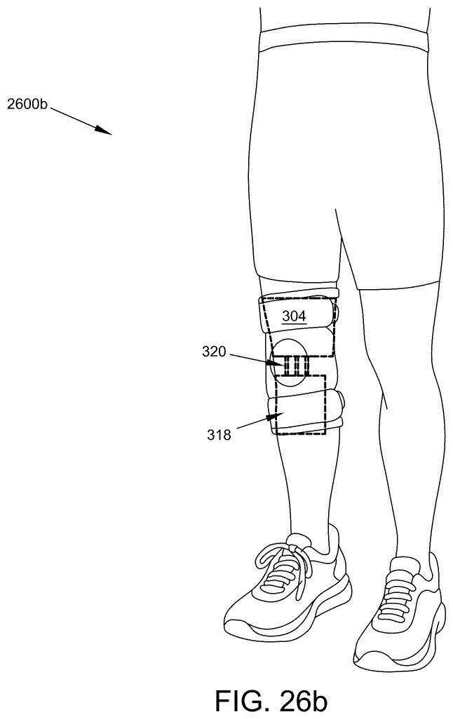

FIGS. 26a and 26b illustrate therapeutic garments 2600 the operable therapeutic components in different locations on the subject in accordance with some embodiments. For example, FIG. 26a shows garment 2600 with the reservoir engaged with the subject's posterior and therapeutic portion 304 engaged with the subject's thigh. Consequently, the subject sitting down will apply the therapeutic pressure, stimulus, or massage effect to the subject's thigh. The subject, once seated, may rock back and forth laterally to apply periodic therapeutic pressure bursts. FIG. 26b shows the reservoir 318 engaged with the subject's knee joint and therapeutic portion engaged with the subject's thigh. When the subject bends their knee joint, the therapeutic pressure, stimulus, or massage effects the subject's thigh.

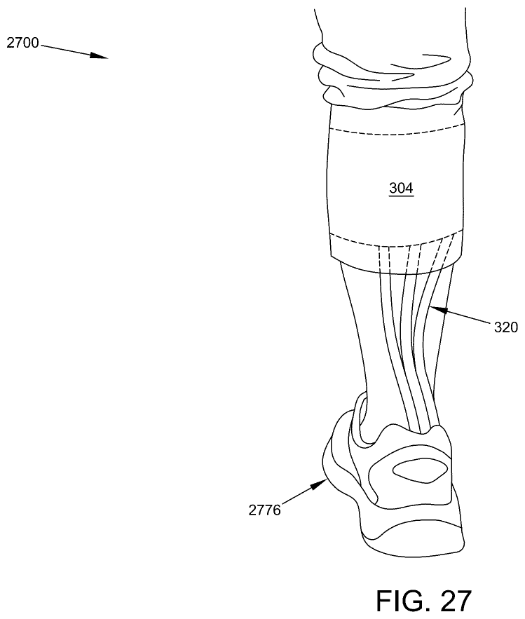

FIG. 27 illustrates a therapeutic device 2700 integrated with a shoe 2776 in accordance with some embodiments. Device 2700 may be similar to the other devices and garments described herein, e.g., device 300. However, the reservoir 318 may be integrated into a shoe, e.g., the sole of the shoe 2776. In some embodiments, reservoir 318 may be integrated into an insert to be placed inside shoe 2776. Shoe 2776 may contain internal passages (not shown) through which tubes 320 may pass to operatively couple reservoir 318 and the therapeutic portion 304.

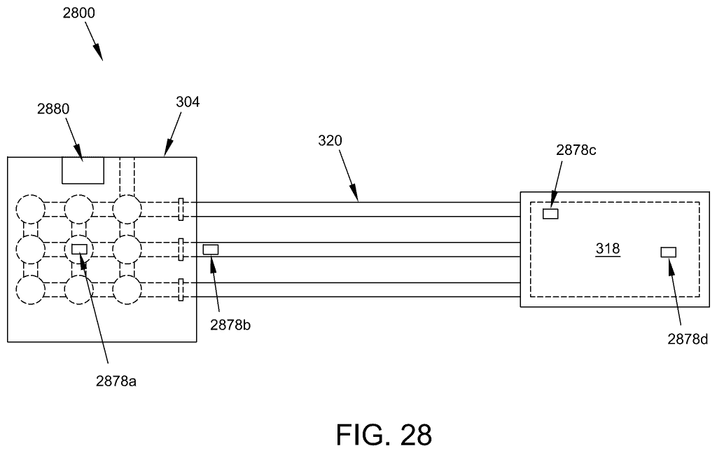

FIG. 28 illustrates a therapeutic device 2800 in accordance with some embodiments. Device 2800 may comprise the above-described therapeutic portion 304, reservoir 318, and tubes 320. Device 2800 may further comprise the additional components described above for use with therapeutic devices and garments, e.g., valves, return lines, etc. Device 2800 may further comprise one or more pressure sensors 2878 and a data port 2880. Pressure sensors may be placed in various locations. For example, pressure sensor 2878a may be placed in a cell to sense the fluid pressure therein. Similarly, pressure sensor 2878b may be placed in between a cell and one or more tubing lines 320, pressure sensor 2878c may be placed in an internal cavity of reservoir 318, and pressure sensor 2878d may be placed in another internal cavity of reservoir 318 to sense fluid pressure therein. Alternatively, these pressure sensors 2878a-2878c may be placed more proximate to the subject such that the sensed pressure is more indicative of the pressure applied to or by the subject.

Data port 2880 may comprise an interface for reading the pressure sensors 2878 and/or transmitting them to an external computer. It may further comprise a memory for storing these readings and/or a battery or other power source for powering the memory and pressure sensors.

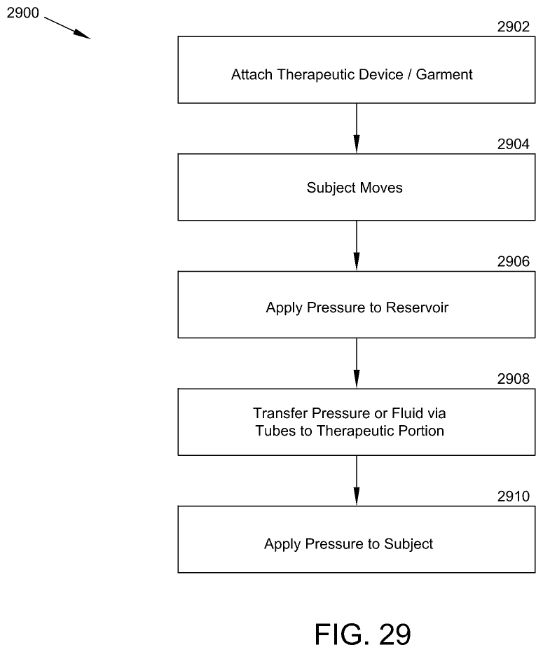

FIG. 29 illustrates a method 2900 of applying a therapeutic treatment to a subject in accordance with some embodiments. In block 2902, a therapeutic device or garment is attached to the subject. The therapeutic device or garment may be any of the therapeutic devices or garments described above. In block 2904, the subject moves which, in turn, applies a pressure to the reservoir (e.g., reservoir 318) as described above in block 2906. This pressure is transferred (and/or causes fluid to flow) to a therapeutic portion via the tubes (e.g., therapeutic portion 304 and tubes 320, described above) in block 2908. In block 2910, a pressure is applied to the portion of the subject with which the therapeutic portion is in contact as a therapeutic pressure, stimulus, or massage effect. The method may continue as the subject continues to move, releasing pressure from the reservoir which eventually allows a pressure relief from the therapeutic portion 304, via tubes 320, back to the reservoir.

Embodiments describe herein provide a passive self-driven (e.g., by movement of the subject) wearable physical therapy device that causes a therapeutic pressure, stimulus, or massage effect that is designed to enhance blood circulation and reduce muscle stiffness. The device consists of a therapeutic portion (e.g., a cell pack with flexible cells), a reservoir (which may be a “super” for larger cell), and interconnecting tubes. In accordance with some embodiments, the cell pack is secured around the calf, while the supercell is placed under the foot. As the user steps on the supercell, the working fluid inside is compressed and transferred to the cell pack, generating controlled pressure that effectively massages the muscles. This self-driven mechanism eliminates the need for external power sources, making the device completely energy independent. Additionally, by using a remote reservoir (e.g., a “supercell”) a higher-pressure output is achievable while not restricting mobility, allowing users to walk, exercise, and engage in daily activities without disruption. In accordance with some embodiments, the subject is able to control internal pressure of the device. Using a self-regulated design, users can adjust the pressure by controlling the amount of inserted working fluid and/or by allowing the working fluid to bypass the therapeutic portion, ensuring a personalized therapy experience. The devices described offer an advanced, convenient, and efficient solution for individuals seeking improved circulation and muscle relief during movement.

Although the subject matter has been described in terms of various embodiments, the disclosure should be construed broadly, to include other variants and embodiments, which may be made by those skilled in the art in light of the teachings disclosed herein.

What is claimed is:

1. A device for providing a therapeutic stimulus to a subject, comprising:
a therapeutic portion configured to engage a first portion of the subject;
a reservoir remote from the therapeutic portion and configured to engage a second portion of the subject;
a tube operatively coupling the therapeutic portion and the reservoir; and
a working material disposed within the therapeutic portion, reservoir, and tube;
wherein the tube is configured to transfer pressure applied to the reservoir by a movement of the subject from the reservoir to the therapeutic portion.

2. The device of claim 1, further comprising a plurality of tubes operatively coupling the therapeutic portion and the reservoir.

3. The device of claim 1, wherein the therapeutic portion, the reservoir, and the tube comprise an elastomer.

4. The device of claim 1, where the tube is removably coupled to at least one of the therapeutic portion and the reservoir.

5. The device of claim 1, further comprising a material surrounding at least one of the therapeutic portion and the reservoir and configured to be placed between the subject and the at least one of the therapeutic portion and the reservoir.

6. The device of claim 1, further comprising a material configured to tightly fit against the subject, the material extending between and coupling the therapeutic portion, the reservoir, and tube to one another.

7. The device of claim 1, wherein the reservoir is integrated into a shoe configured to be worn by the subject.

8. The device of claim 1, wherein the reservoir is configured to have a shape and size that conforms to the second portion of the subject.

9. The device of claim 1, wherein the therapeutic portion comprises:
a plurality of cells, each cell comprising:
a perimeter wall;
an inner layer configured engage the first portion of the subject; and
an outer layer substantially parallel to the inner layer and displaced from the inner layer by the wall;
wherein the wall, the inner layer, and the outer layer define an internal cavity; and
a plurality of channels, each channel coupling the internal cavity defined by one cell of the plurality of cells to the internal cavity defined by another cell of the plurality of cells,
wherein the working material is disposed in the internal cavity of each of the plurality of cells and the plurality of channels.

10. The device of claim 1, further comprising a strap attached to the tube configured to maintain the tube in close proximity to the subject.

11. The device of claim 1, further comprising a valve allowing the working material to be added or removed.

12. The device of claim 1, further comprising a pressure sensor.

13. The device of claim 1, wherein the first portion is a limb of the subject and the second portion is an extremity of the subject.

14. The device of claim 1, wherein the first portion of the subject is a calf muscle.

15. The device of claim 1, wherein the second portion of the subject is a foot.

16. The device of claim 1, wherein the working material is a fluid or gel.

17. The device of claim 1, wherein the working material is a hydrogel or composition of water, polyvinyl alcohol, and borax.

18. The device of claim 1, wherein the each of the first portion of the subject and the second portion of the subject are predetermined, and the therapeutic portion and the reservoir are configured to engage the first and second portions, respectfully.

19. A therapeutic garment, comprising:
a therapeutic portion configured to engage a first portion of a subject;
a reservoir remote from the therapeutic portion and configured to engage a second portion of the subject;
a tube operatively coupling the therapeutic portion and the reservoir; and
a working material disposed within the therapeutic portion, the reservoir, and the tube,
wherein the tube is configured to transfer pressure applied to the reservoir by a movement of the subject from the reservoir to the therapeutic portion.

20. A method for applying a therapeutic treatment to a subject, comprising
attaching a therapeutic device to a subject, wherein the therapeutic device comprising:
a therapeutic portion configured to engage a first portion of the subject;
a reservoir remote from the therapeutic portion and configured to engage a second portion of the subject;
a tube operatively coupling the therapeutic portion and the reservoir; and
a working material disposed within the therapeutic portion, the reservoir, and the tube; and
applying a pressure to the reservoir through a movement of the subject, wherein the pressure is transferred from the reservoir to the therapeutic portion via the tube, the transferred pressure applying pressure to the first portion of the subject.
